(19) United States
(12) Patent Application Publication
(10) Pub. No.: US 2026/0350050 A1
(43) Pub. Date: Nov. 5, 2026

(54) SYSTEMS AND METHODS FOR A FRAMEWORK FOR METADATA ENRICHMENTS USING OPEN-SOURCE DATA

(71) Applicant: JPMORGAN CHASE BANK, N.A., New York, NY (US)

(72) Inventors: Brenda NG, Danville, CA (US); Smruthi MUKUND, San Jose, CA (US); Munjela RUMANNA, Pittsburg, CA (US)

(21) Appl. No.: 19/197,167

(22) Filed: May 2, 2025

(51) Int. Cl. G06F 16/3329; G06F 16/335; G06F 16/383

(52) U.S. Cl. CPC G06F 16/3329; G06F 16/335; G06F 16/383

(57) ABSTRACT

In some embodiments, the techniques disclosed herein relate to a method including: receiving, through an application executed by one or more processors, a plurality of transactions, the plurality of transactions and/or catalogs stored in a database in a temporary memory accessible the application; extracting, by the application, entities from the plurality of transactions; filtering, by the application, a portion or subset of the entities from the plurality of transactions; generating, by the application, a name prompt based on a prompt template for the name of entities for reconciliation, the prompt template including a query for a LLM for a name of each of the name of entities find a similarity between a listed entity and a category and a likely target entity.

### BACKGROUND

### 1. Field of The Invention

Embodiments generally relate to systems and methods for metadata enrichments using open-source data.

### 2. Description of the Related Art

Current profile analysis of banking interactions suffers from poor data input and validation, costly manual profile reviews, and poor data production processes. For example, a financial institution may analyze a vendor's profile to assess the appeal of its offerings to the customers, using existing customer interactions and transactions with the vendor as a reference point. However, conventional systems are incomplete, rely on manual review of different sources that cannot be validated and are not repeatable, and are generally focused on the vendor's firmographic data as opposed to its specific customer-centric offerings. Improved systems and methods will be transparent, improve the data quality, be able to validate the data creation process and data, and be automated so as to quickly and efficiently conduct profile analysis. Further, large language model (“LLM”) techniques may be leveraged to generate metadata for a given profile with respect to a specific list of attributes so as to provide expansive analysis results that incorporate commonsense knowledge about said vendors. Improved systems and methods may also use and query knowledge graphs for quick, efficient profile retrieval and generation of related specific information.

### SUMMARY

Exemplary embodiments provide systems and methods for metadata enrichments using open-source data. According to one embodiment, a method may include receiving, through an application executed by one or more processors, a plurality of transactions and/or catalogs, the plurality of transactions and/or catalogs stored in a database in a temporary or permanent memory accessible the application; extracting, by the application, entities from the plurality of transactions and/or catalogs; filtering, by the application, a portion or subset of the entities from the plurality of transactions and/or catalogs; generating, by the application, a name prompt based on a prompt template for the name of entities for reconciliation, the prompt template including a query for a LLM for a name of each of the name of entities find a similarity between a listed entity and a category and a likely target entity; generating, by a LLM executed by a server, name responses based on the name prompt and parameters; parsing, by the application, responses to generate reconciled names of entities; generating, by the application, a metadata prompt for metadata generation based on a metadata prompt template the reconciled name of entities, the metadata prompt template including a query to a metadata generation LLM to generate attributes for the reconciled name of entities; generating, by a response LLM executed by the server, metadata response based on metadata prompt and parameters; and parsing responses, by the application, to generate reconciled metadata by extracting subjective attributes for reconciled names. In some embodiments, the attributes may exclude subjective attributes.

In some embodiments, the prompt template may include a requirement to require a response in a structured format. In some embodiments, the prompt template may include a requirement to require a confidence level. In some embodiments, the metadata responses may be filtered based on confidence level. In some embodiments, if the confidence is low, the vendor name reconciliation may be iterated with more a time, a date, or a location. In some embodiments, the method may comprise requesting data from an offline database, by the application from an in-memory data structure, and receiving a frequently-accessed metadata. In some embodiments, the method may comprise requesting data from a self-contained SQL database engine if the frequently-accessed metadata is not available or incomplete from the in-memory data structure, by the application, and receiving a second-tier metadata, wherein the self-contained SQL database engine has a higher latency than the in-memory data structure. In some embodiments, the method may comprise requesting data from a cold cache if the second-tier metadata is not available or incomplete from the in-memory data structure and the self-contained SQL database engine, by the application, and receiving a third-tier metadata, wherein the cold cache has a higher latency than the in-memory data structure and the self-contained SQL database engine. In some embodiments, the method may comprise invoking, by the application, a metadata generation LLM through an API to generate metadata if the third-tier metadata is not available or incomplete. In some embodiments, the method may comprise updating, by the application, a storage hierarchy by moving the second-tier metadata or the third-tier metadata to the in-memory data structure or the self-contained SQL database engine based on what information is received based on the requesting data steps

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1A is a block diagram of a system for metadata enrichments using open-source data, in accordance with embodiments.

FIG. 1B is a block diagram of a system for metadata enrichments using open-source data, in accordance with embodiments.

FIG. 2 is a method for metadata enrichments using open-source data, in accordance with embodiments.

FIG. 3 is a method for verifying metadata enrichments using open-source data, in accordance with embodiments.

FIG. 4 is a method for storing the metadata enrichments using open-source data, in accordance with embodiments.

FIG. 5 is a method for data structure retrieval, in accordance with embodiments.

FIG. 6 is a method for metadata enrichment monitoring, in accordance with embodiments.

FIG. 7 is a block diagram of a computing device for implementing certain embodiments of the present disclosure.

### DETAILED DESCRIPTION

Embodiments generally relate to systems and methods for metadata enrichments using open-source data.

Conventional systems include profile analysis of interactions (e.g., banking interactions”) suffer from poor data input and validation, costly manual profile reviews, and poor data production processes. For example, a financial institution may analyze a vendor's profile to assess the appeal of its offerings to the customers, using existing customer interactions and transactions with this vendor as a reference point. These systems provide incomplete and missing information that cannot be verified and requires significant manual review. Improved systems and methods consistent with embodiments described herein improve transparency of data, improve the data quality, are able to validate the data creation process and data, and are automated so as to quickly and efficiently conduct profile analysis as compared to conventional systems. Further, systems and methods include or in operable communication with a large language model (“LLM”) that generates metadata for a given profile with respect to a specific list of attributes so as to provide expansive analysis results that incorporate commonsense knowledge about said vendors. These improved systems and methods may generate, use, and query knowledge graphs for faster and more efficient profile retrieval and generation of related specific information than conventional machine learning models.

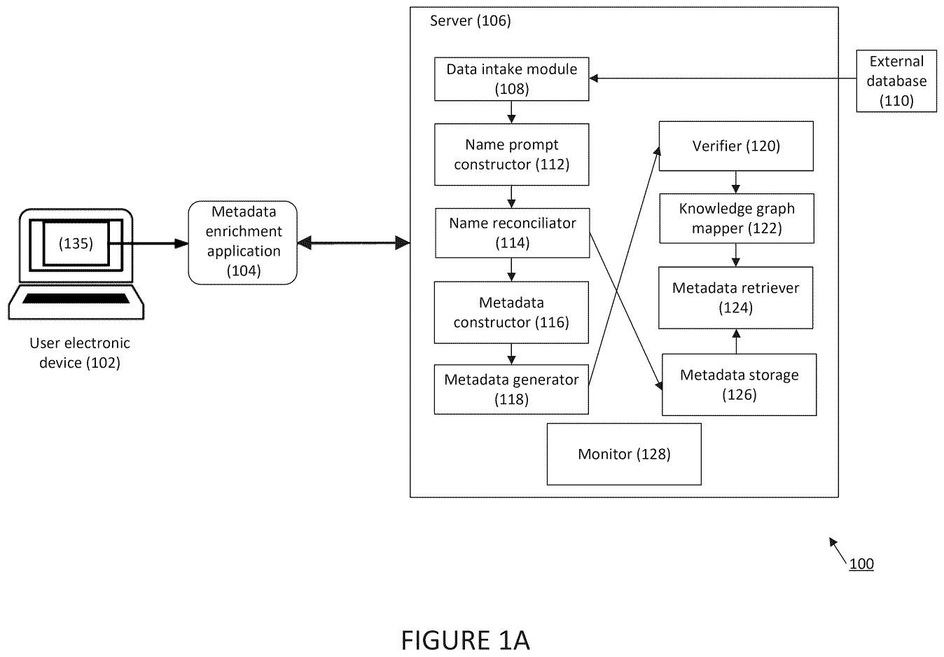

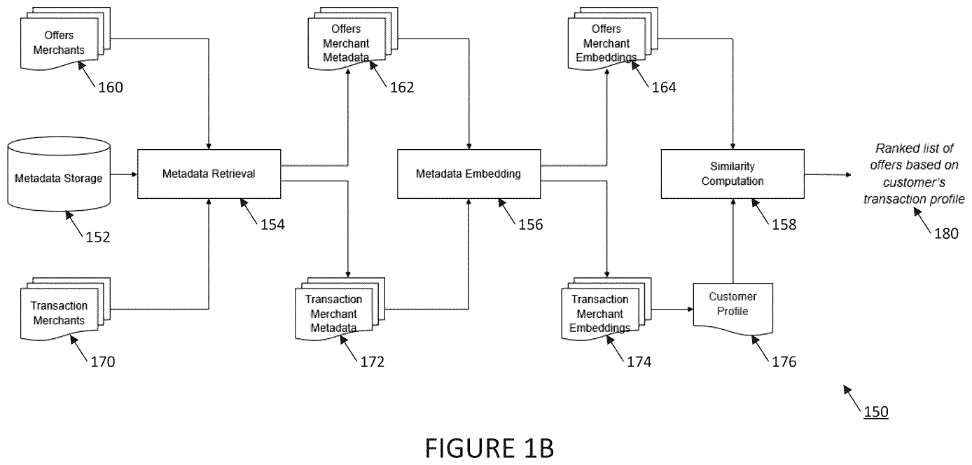

FIG. 1A is a block diagram of a system for metadata enrichments using open-source data, in accordance with embodiments.

System 100 includes a user electronic device 102 executing metadata enrichment application 104 available through user interface 135, a server 106 comprising a network or computer including a processor executing one or more software modules and a memory for storing data accessible by the one or more software modules and instructions to execute the one or more software modules. The one or more software modules may include a data intake module 108, a name prompt constructor 112, a name reconciliatory 114, a metadata constructor 116, a metadata generator 118, a verifier 120, a knowledge graph mapper 122, a metadata retriever 124, a metadata storage 126, and monitor 128. One or more databases of server 106 may be accessed and/or include instructions for the one or more software modules.

Application 104 executed by one or more processors of user communication device 102 may access one or more databases of transactions and/or catalogs. User communication device 102 may be a computer configured to communicate over a wired or wireless interface with a computer network or Internet with server 106. The transactions and/or catalog may be stored on an external database 110 such as in a temporary or permanent database. The external database 110 may be a cloud-based memory or a computer network memory. In some embodiments, the transactions and/or catalog may be part of an internal database such as a memory or a group of memories as part of a computer network comprising server 106.

Application 104 may comprise an advertisement generation application configured to communicate with server 106.

Data intake module 108 may include receiving a plurality of transactions and/or catalogs from one or more systems in communication with server 106 such as a merchant computer system or vendor computer system. The plurality of transactions and/or catalogs may be stored in a database in a temporary or permanent memory accessible the application. A transaction may be a recorded interaction between two entities. For example, the transaction may be a monetary transfer between a vendor and a customer, where the recorded interaction includes the vendor name, customer name, amount, time, type of payment, etc. A catalog may be a list of entities or product offerings. The list of entities or product offerings may be associated with a vendor. In some embodiments, a plurality of transactions may be used to establish the customer's propensities such as customer's traveling or spending propensities. The catalogs may include time-sensitive promotional offers that a financial institution can provide to the customer as incentives to spend at vendors associated with the offers (e.g., bonus reward points or statement cashback). Data intake module 108 may extract entities from the plurality of transactions and/or catalogs. In some embodiments, more than one entity may be listed such as a doing business as name, a parent name, or a subsidiary name.

Name prompt constructor 112 may generate a name prompt based on a prompt template for the name of entities for reconciliation. The prompt template may include a query for a LLM for a name of each of the name of entities. The prompt template may be instantiated with a specific vendor name, and a collection of prompts may thus be formed for batch name reconciliation by the LLM. The prompt template may seek to find similarities between a listed entity and a category, together, and a likely target entity. For example, a category of food, automotive, or other general category and the listed entity may help identify the likely target entity. In some embodiments other information may be used to identify the likely target entity such as time, price, or location. The prompt template may include a requirement to require a response in a structured format (e.g., JSON). The prompt template may include a requirement to require a confidence level

Name reconciliatory 114 may generate a name prompt based on a prompt template for the name of entities for reconciliation. The prompt template may include a query for a LLM for a name of each of the name of entities. The prompt template may be instantiated with a specific vendor name, and a collection of prompts may thus be formed for batch name reconciliation by the LLM. The prompt template may seek to find similarities between a listed entity and a category, together, and a likely target entity. For example, a category of food, automotive, or other general category and the listed entity may help identify the likely target entity. In some embodiments other information may be used to identify the likely target entity such as time, price, or location. The prompt template may include a requirement to require a response in a structured format (e.g., JSON). The prompt template may include a requirement to require a confidence level

Metadata constructor 116 may generate, by a LLM of metadata constructor 116 or accessible by server 106 and in operative communication with server 106 through an internet connection and/or an application programming interface (“API”), name responses based on the name prompt and parameters. The name responses may be requested in a batch with parallel calls to the LLM for efficiency and to reduce cost.

Metadata generator 118 may generate a metadata prompt for metadata generation based on a metadata prompt template the reconciled name of entities. The metadata prompt template may include a query to a metadata generation LLM to generate business-relevant attributes for the reconciled name of entities. The attributes may include industries, products, services, competitors, or any other attribute information. The prompt template may be instantiated with the reconciled name. The result may be a collection of prompts that may be provided to the metadata generation LLM as a batch for batch metadata generation. The metadata prompt template may seek to generate comprehensive information of the reconciled name. The metadata prompt template may include a requirement to require a response in a structured format (e.g., JSON). The metadata prompt template may include a requirement to require a confidence level. The metadata prompt may query to generate an associated category along with the metadata, the associated category being a list, a type, a description, a title or label, or a URL. The prompt template may be saved and provided to a user interface (e.g., user interface 135) to provide transparency in a reduced cost manner that is also traceable and verifiable.

Verifier 120 may split the input metadata into individual claims. Each individual claim may be a single fact. Verifier 120 may discard a claim or tag that is non-verifiable. For each individual claim, the application may determine the claim can be verifiable as a yes/no query or not. For claims that are not binary and/or factual (e.g., opinion, low confidence), the claims may be discarded or tagged for further review (e.g., by a check LLM). Only claims that are binary and/or factual may be stored. Verifier 120 may generate one or more verification queries for the check LLM. A verification query maps the claim statement into a question. Verification may allow a verifiable fact-checking process where the LLM-generated metadata is compared to offline database and real-time search API results so verification is relatively certain as compared to conventional systems and methods.

Verifier 120 may query one or more knowledge sources in order to complete verification. The verification queries may be used to determine which knowledge source(s) to fetch evidence for vetting the claim, along with how to instantiate the knowledge source query. If querying a real-time search API, then the verification query may be mapped to keywords and specific search parameters to formulate the API call. If querying offline data dumps using a retrieval model, then the verification query itself may be used to fetch the most semantically similar content in the data dumps. If the check LLM is implemented as part of an agentic framework, one may assume that there is an agent that can query a specific knowledge base and would apply its internal LLM to formulate these queries given the tool description of these knowledge sources. Each agent will return the evidence from its respective knowledge source that it deems pertinent to verifying the claim, along with the rationale for said evidence.

Verifier 120 may verify claims including generating a confidence for each claim. The evidence(s) provided by the knowledge source(s) from Step 350 are combined with the verification query from Step 340 as input to the check LLM. If presented with evidence from multiple sources, the check LLM may verify based on the confluence of these sources' evidence. If the knowledge source provides a confidence about its true/false response regarding the claim, then this will be included as the confidence value for the verified claim. If a specific knowledge source is more trustworthy than other sources, this trustworthy measure will also be factored into the claim confidence. It is best to consult the business teams (users of the metadata) for ranking of knowledge sources. In some embodiments, a number of check LLMs with different decision weights and/or parameters (e.g., randomness, a maximum number of tokens generated, frequency and/or presence penalties) may be used as a reasoning ensemble. Each check LLM may generate a vote for the same claim, and the results of the check LLMs may be aggregated accordingly to provide the final yes/no verification for the said claim. Verifier 120 may extract a subset of claims for the check LLM to generate gold standard claims. The subset of claims that are verified by multiple high-confidence knowledge sources may be used as a gold standard to finetune the check LLM. In some embodiments in which a number of check LLMs may be used as a reasoning ensemble, the claims with the highest number of votes (e.g., above eighty or ninety percent of participating LLMs) may be selected as gold standard claims

Knowledge graph mapper 122 may define graph schema based on prompt template for metadata generation and verified claims. The metadata prompt may contain specific attributes that are used by the application to define the types of nodes and relationships to include in the knowledge graph. The set of nodes and relationships will be referred to as the schema of the knowledge graph

Metadata retriever 124 may be pull input metadata from metadata storage, transaction(s) from one or more merchants or vendors, and/or from offers by one or more merchants or vendors 160. Metadata retrieval may separate the input metadata into transaction(s) of one or more merchants or vendors, and/or offers by one or more merchants or vendors.

Metadata storage 126 may include a memory of a server, computer, or on a cloud that may be accessible by one or more applications through an application programming interface (“API”) and/or an internet or network connection.

Monitor 128 may generate logs and metrics aby tracking logs and metrics as time-series data at a collection. Monitor 128 may generate logs and metrics (e.g., API response time, error rates, cache hits/misses). The collection may be a metrics collection. Monitor 128 may ping one or more systems and receive and store key metrics such as CPU usage, API latency, LLM token count, memory consumption, and failures. Monitor 128 may continuously scrape and update the metrics database. Reducing LLM count by monitoring by monitor 128 may be advantageous to reduce the cost of communicating with LLMs due to rate-limiting policies such as a threshold number of tokens and/or a threshold number of tokens in a time period (e.g., an hour).

Monitor 128 may generate key performance indicators from collection and displaying a real-time dashboard with the key performance indicators. Monitor 128 may be in operative communication with a display real-time dashboard for health checks, request counts, and error rates (e.g., through user interface 135 of user electronic device 102).

Monitor 128 may monitor one or more thresholds. The thresholds may be, for example, API latency greater than two seconds, memory usage greater than 80%, etc. Monitor 128 may send an alert if a threshold is met or breached/surpassed.

Monitor 128 may send real-time notifications via API responses to relevant channels. Monitor 128 may send real-time notifications to relevant channels. One or more target channels may receive alerts via a messenger service or an email with a recommended action based on the alert (e.g., provide more storage, produce more processors). Monitoring via monitor 128 may ensure real-time issue detection, allowing quick response to failures or performance degradation.

FIG. 1B is a block diagram of a system for metadata enrichments using open-source data, in accordance with embodiments.

Metadata storage 152 may be similar to metadata storage of 126. Metadata storage 152 may include a memory of a server, computer, or on a cloud that may be accessible by one or more applications through an application programming interface (“API”) and/or an internet or network connection. Metadata retrieval 154 may pull input metadata from metadata storage 152, transaction(s) from one or more merchants or vendors, and/or from offers by one or more merchants or vendors 160. Metadata retrieval 154 may separate the input metadata into transaction(s) of one or more merchants or vendors 162, and/or offers by one or more merchants or vendors 172. The input metadata may be stored in a temporary memory accessible by one or more processors executing as part of a server or computer.

An embedding model executed by the one or more processors may embed metadata of received transaction(s) of one or more merchants or vendors 162, and/or offers by one or more merchants or vendors 172. Each merchant or vendor may have a set of embeddings generated by the embedding model. The embedding model may output embeddings including offers embeddings 164 and/or transactions embeddings 174. The embeddings may be stored in a temporary memory accessible by one or more processors executing as part of a server or computer. From transactions embeddings 174, a customer profile 176 may be generated by an application executed by the one or more processors. The customer profile may be generated from a statistical analysis of the transactions embeddings. The statistical analysis may be a clustering analysis where any outlier transactions may be discarded followed by an aggregation of commonly occurring transactions. The customer profile may be a vector that represents a customer's spending or travel propensity. Similarity computation 158 may include comparing the customer profile 176 against offers embeddings to identify merchants or vendors that align with the customer's spending or travel propensity. A ranked list of offers 180 may be output based on the similarity computation 158. The ranking may be based on the similarity (e.g., where more similar equates to a higher ranking). A portion of the ranked list of offers 180 may be selected (e.g., a top n amount such as a top one offer or five offers) for execution. In some embodiments, a communication application may generate and send one or more email, text, voice, or letter communications based on the selected offers.

This process may include similarities between naming and matching information for determining likely products, issues, or conflicts relating to a target profile's history of transactions, computer assets, or combinations of software and hardware, respectively. Disclosed systems and methods provide superior metadata enrichment as compared to conventional systems and methods.

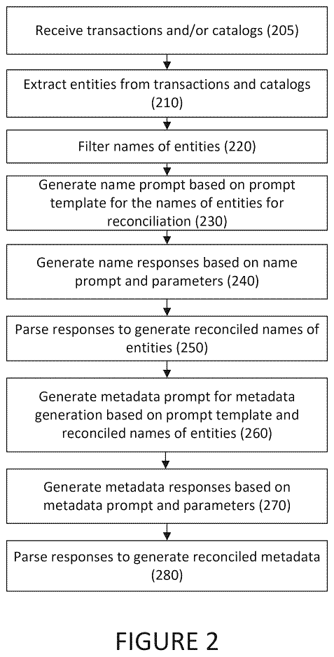

FIG. 2 is a method for metadata enrichments using open-source data. The method may be stored as a list of instructions stored on a memory that when executed by one or more processors cause the one or more processors to perform the method.

Step 205 may include receiving, through an application executed by one or more processors, a plurality of transactions and/or catalogs. The plurality of transactions and/or catalogs may be stored in a database in a temporary or permanent memory accessible the application. A transaction may be a recorded interaction between two entities. For example, the transaction may be a monetary transfer between a vendor and a customer, where the recorded interaction includes the vendor name, customer name, amount, time, type of payment, etc. A catalog may be a list of entities or product offerings. The list of entities or product offerings may be associated with a vendor. In some embodiments, a plurality of transactions may be used to establish the customer's propensities such as customer's traveling or spending propensities. The catalogs may include time-sensitive promotional offers that a financial institution can provide to the customer as incentives to spend at vendors associated with the offers (e.g., bonus reward points or statement cashback).

Step 210 may include extracting, by the application, entities from the plurality of transactions and/or catalogs. In some embodiments, more than one entity may be listed such as a doing business as name, a parent name, a subsidiary name, or so on.

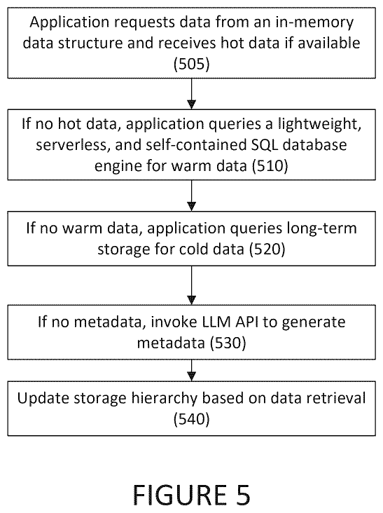

Step 220 may include filtering a portion or subset of the entities. The entities on one side of a transaction may be identified. For example, vendors or payees may be identified. The identified entities may be matched against already-processed entities that have already gone through the metadata generation process, as there is no need to repeat the process if the metadata for this entity already exists in the metadata storage. More description is included in the description of FIG. 5.

Step 230 may include generating, by the application, a name prompt based on a prompt template for the name of entities for reconciliation. The prompt template may include a query for a LLM for a name of each of the name of entities. The prompt template may be instantiated with a specific vendor name, and a collection of prompts may thus be formed for batch name reconciliation by the LLM. The prompt template may seek to find similarities between a listed entity and a category, together, and a likely target entity. For example, a category of food, automotive, or other general category and the listed entity may help identify the likely target entity. In some embodiments other information may be used to identify the likely target entity such as time, price, or location. The prompt template may include a requirement to require a response in a structured format (e.g., JSON). The prompt template may include a requirement to require a confidence level.

Step 240 may include generating, by a LLM, name responses based on the name prompt and parameters. The LLM may be operated by the server or be in operative communication with the server. The name responses may be requested in a batch with parallel calls to the LLM for efficiency and to reduce cost.

Step 250 may include parsing responses to generate reconciled names of entities. Parsing may be accomplished based on the confidence level. If the confidence is low, the vendor name reconciliation (steps 230-240) may be iterated with more information (e.g., time, date, location).

Step 260 may include generating a metadata prompt for metadata generation based on a metadata prompt template the reconciled name of entities. The metadata prompt template may include a query to a metadata generation LLM to generate business-relevant attributes for the reconciled name of entities. The attributes may include industries, products, services, competitors, or any other attribute information. The prompt template may be instantiated with the reconciled name. The result may be a collection of prompts that may be provided to the metadata generation LLM as a batch for batch metadata generation. The metadata prompt template may seek to generate comprehensive information of the reconciled name. The metadata prompt template may include a requirement to require a response in a structured format (e.g., JSON). The metadata prompt template may include a requirement to require a confidence level. The metadata prompt may query to generate an associated category along with the metadata, the associated category being a list, a type, a description, a title or label, or a URL.

Step 270 may include generating, by a response LLM, metadata response based on metadata prompt and parameters. The response LLM may be operated by the server or be in operative communication with the server. The name responses may be requested in a batch with parallel calls to the response LLM for efficiency and to reduce cost.

Step 280 may include parsing responses to generate reconciled metadata. The metadata responses may be parsed to extract attributes for reconciled names. In some embodiments, the attributes may exclude subjective attributes (e.g., stated opinions based on nomenclature such as “best,” “worst,” “greatest,” etc.). The metadata responses may be filtered based on confidence level (e.g., excluding low confidence). If the confidence is low, the vendor name reconciliation (steps 270-280) may be iterated with more information (e.g., time, date, location).

The application may be a metadata enrichment application. The application may generate one or more ads based on metadata enrichment.

As an example, a customer may be associated with a history of transactions stored as part of a database. Each of these transactions is associated with a transaction vendor.

An offer may be associated with an offer vendor that is offering the promotion. In order to match the right offers to the right customers, one may leverage the semantic overlap between the offer vendors (i.e., the vendors with the promotions) and the transaction vendors (i.e., the vendors that the customer has transacted with). For these two sets of vendors, the application may retrieve the metadata from each vendor. For each vendor, the relevant information from the retrieved metadata may be mapped to vector representations by using an embedding model. Each vendor may have its own set of embeddings.

From the transaction vendor embeddings, the application may perform statistical analysis such as clustering to remove any “outlier” transactions and then aggregate the commonly occurring transactions to build up a customer profile, which in turn is another vector that represents the customer's general spending propensity. The vector may represent the customer's profile and be compared against each of the offers vendor embeddings to identify the vendors that align with this customer's spending propensity. A ranked list of offers may be the output of the application in connection with a display (e.g., of a computer or mobile device), and the top-k offers may be sent to one or more customers. The offers may be part of a marketing campaign.

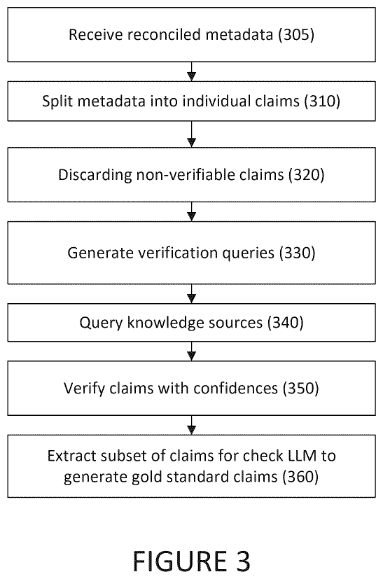

FIG. 3 is a method for verifying metadata enrichments using open-source data. The method may be stored as a list of instructions stored on a memory that when executed by one or more processors cause the one or more processors to perform the method.

Step 305 may include receiving reconciled metadata. Reconciled metadata may be received by a module in operative communication with the application of FIG. 2.

Step 310 may include splitting metadata into individual claims. Each individual claim may be a single fact.

Step 320 may include discarding a claim or tag that is non-verifiable. For each individual claim, the application may determine the claim can be verifiable as a yes/no query or not. For claims that are not binary and/or factual (e.g., opinion, low confidence), the claims may be discarded or tagged for further review (e.g., by a check LLM). Only claims that are binary and/or factual may be stored.

Step 330 may include generating one or more verification queries for the check LLM. A verification query maps the claim statement into a question. This question will be appended to the output of Step 350 as input to Step 360.

Step 340 may include querying one or more knowledge sources. The verification queries from Step 330 may be used to determine which knowledge source(s) to fetch evidence for vetting the claim, along with how to instantiate the knowledge source query. If querying a real-time search API, then the verification query may be mapped to keywords and specific search parameters to formulate the API call. If querying offline data dumps using a retrieval model, then the verification query itself may be used to fetch the most semantically similar content in the data dumps. Offline data may be local and secured. Offline data may not be connected to an internet. If the check LLM is implemented as part of an agentic framework, one may assume that there is an agent that can query a specific knowledge base and would apply its internal LLM to formulate these queries given the tool description of these knowledge sources. Each agent will return the evidence from its respective knowledge source that it deems pertinent to verifying the claim, along with the rationale for said evidence.

Step 350 may include verifying claims with confidences. The evidence(s) provided by the knowledge source(s) from Step 350 are combined with the verification query from Step 340 as input to the check LLM. If presented with evidence from multiple sources, the check LLM may verify based on the confluence of these sources' evidence. If the knowledge source provides a confidence about its true/false response regarding the claim, then this will be included as the confidence value for the verified claim. If a specific knowledge source is more trustworthy than other sources, this trustworthy measure will also be factored into the claim confidence. It is best to consult the business teams (users of the metadata) for ranking of knowledge sources. In some embodiments, a number of check LLMs with different decision weights and/or parameters (e.g., randomness, a maximum number of tokens generated, frequency and/or presence penalties) may be used as a reasoning ensemble. Each check LLM may generate a vote for the same claim, and the results of the check LLMs may be aggregated accordingly to provide the final yes/no verification for the said claim.

Step 370 may include extracting a subset of claims for the check LLM to generate gold standard claims. The subset of claims that are verified by multiple high-confidence knowledge sources may be used as a gold standard to finetune the check LLM. In some embodiments in which a number of check LLMs may be used as a reasoning ensemble, the claims with the highest number of votes (e.g., above eighty or ninety percent of participating LLMs) may be selected as gold standard claims.

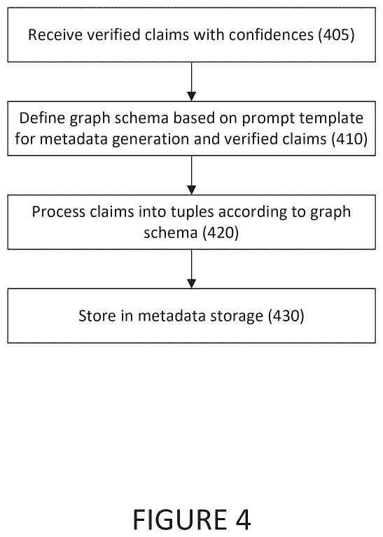

FIG. 4 is a method for storing the metadata enrichments using open-source data. The method may be stored as a list of instructions stored on a memory that when executed by one or more processors cause the one or more processors to perform the method.

Step 405 may include receiving verified claims with confidences such as those produced according to FIG. 3.

Step 410 may include defining graph schema based on prompt template for metadata generation and verified claims. The metadata prompt may contain specific attributes that are used by the application to define the types of nodes and relationships to include in the knowledge graph. The set of nodes and relationships will be referred to as the schema of the knowledge graph.

Step 420 may include processing claims into tuples according to graph schema. A verified claim from FIG. 3 will be mapped to a tuple relating the entity to a property. This property may involve another entity. Specifically, the claims are processed into tuples of the form (NODE)-[RELATIONSHIP]-(NODE). For example: (Company: “Burgers For Everyone”)-[OFFERS]-(Product: “Burgers”) where (Company: “Burgers For Everyone”) is a Company node, (Product: “Burgers”) is a Product node, and they are linked by the [OFFERS] relationship. In the knowledge graph, there can be different types of nodes and relationships.

In some embodiments, some nodes may have node attributes, as in the case of the Company node that has attributes of business type, website and description. These attributes may not link to any other nodes but are intrinsic to the Company node itself.

Step 430 may include storing claims in metadata storage as a knowledge graph. The tuples may be pushed to the graph database that stores this knowledge graph that organizes all the generated and verified metadata. The knowledge graph may include the name (i.e., the name of the entity mentioned in the metadata), a node type (i.e., the entity type), and a relationship type (i.e., the type of interactions that are possible between the named entity and other entities).

FIG. 5 is a method for data structure retrieval. The method may be stored as a list of instructions stored on a memory that when executed by one or more processors cause the one or more processors to perform the method.

Step 505 may include requesting data, by an application, from an in-memory data structure (e.g., hot cache) and receiving the frequently accessed metadata (i.e., hot data) if available. Here, the term “hot cache” refers to a cache that is actively being used and accessed frequently, and is generally designed to return results with low latency.

Step 510 may include querying, if no hot data is available from the in-memory data structure, a self-contained SQL database engine (e.g., warm cache) for warm data. Here, the term “warm cache” refers to a cache that may be a slightly slower storage system that is acceptable for less frequently accessed metadata (i.e., warm data). In some embodiments, the warm cache may be implemented as a self-contained SQL database engine that is lightweight and/or serverless. For example, as trending vendors become less popular, then these vendors' metadata may be demoted from being part of hot data to warm data, because their metadata are now accessed less frequently.

Step 520 may include querying, if no warm data is available from the SQL database engine, querying a long-term storage (e.g., cold cache) for cold data. Here, the term “cold cache” refers to a cache that may be the slowest, most cost-effective storage systems meant for archival storage of rarely accessed metadata (i.e., cold data). For example, vendors that constitute a very small number of customer transactions may be good candidates for storing their metadata as cold data.

Step 530 may include invoking, if no cold data is available, a LLM through an API to generate metadata. This may be generated as discussed above with regards to metadata generation.

Step 540 may include updating a storage hierarchy based on data retrieval. When the warm cache is queried and metadata is found, the hot cache may be updated for faster future access. When long-term storage is queried, the result may be added to the warm cache for persistence. When the LLM API is used, the result may be written back to the hot cache and then may eventually moved down the hierarchy based on the metadata's access frequency. Data may be eventually removed from a cache (e.g., the hot cache) based on cache eviction policies, time to live (“time to live”) expiration, and/or memory constraints. The system may prevent all searches from permanently moving to the hot cache while ensuring a smooth user experience since hot cache is light weight and has a fixed memory limit. Thus, the hot cache cannot support all searches because of memory size. However, the hot cache alleviates cost because using long term storage is relatively expensive and time consuming.

The hierarchy may allow for faster response times because the closer the data is to the application (e.g., measured in time to retrieve), the more likely it may be used by the application. The hot cache may be frequently accessed data, reducing the need to query slower storage (e.g., the self-contained SQL database engine or the long-term storage). This may reduce latency for critical queries. This may improve user experience.

Further, the hierarchy may allow for reduced load on a primary data store. Fetching data from a database or an external API may be expensive in terms of computational cost and time. Requests may be first served from cache layers, preventing unnecessary database queries or API calls and thus improving efficiency over conventional systems and methods.

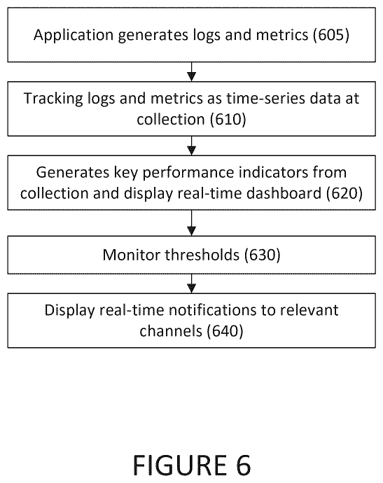

FIG. 6 is a method for metadata enrichment monitoring. The method may be stored as a list of instructions stored on a memory that when executed by one or more processors cause the one or more processors to perform the method.

Step 605 may include generating, by an application, logs and metrics. The application may generate logs and metrics (e.g., API response time, error rates, cache hits/misses).

Step 610 may include, by a collection that receives the logs and metrics from the application, tracking logs and metrics as time-series data at a collection. The collection may be a metrics collection. The collection may store key metrics such as CPU usage, API latency, LLM token count, memory consumption, and failures. The collection may continuously scrape and update the metrics database. Reducing LLM count may be advantageous to reduce the cost of communicating with LLMs due to rate-limiting policies such as a threshold number of tokens and/or a threshold number of tokens in a time period (e.g., an hour).

Step 620 may include generating, by the application, key performance indicators from collection and displaying a real-time dashboard with the key performance indicators. The application may display real-time dashboards for health checks, request counts, and error rates.

Step 630 may include monitoring, by the application, one or more thresholds. The thresholds may be, for example, API latency greater than two seconds, memory usage greater than 80%, etc. An alert may be triggered if a threshold is met or breached/surpassed.

Step 640 may include displaying, by the application, real-time notifications to relevant channels. The application may send real-time notifications to relevant channels. One or more target channels may receive alerts via a messenger service or an email with a recommended action based on the alert (e.g., provide more storage, produce more processors).

Monitoring may ensure real-time issue detection, allowing quick response to failures or performance degradation.

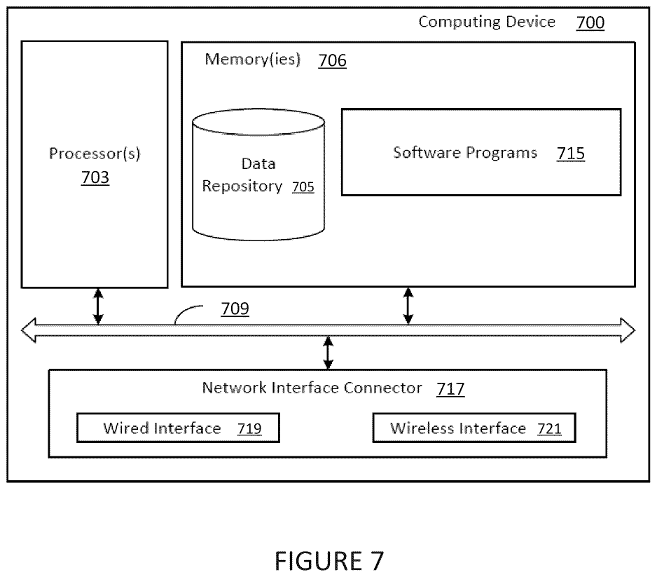

FIG. 7 is a block diagram of a computing device for implementing certain embodiments of the present disclosure. FIG. 7 depicts exemplary computing device 700. Computing device 700 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 700.

Computing device 700 includes a processor 703 coupled to a memory 706. Memory 706 may include volatile memory and/or persistent memory. The processor 703 executes computer-executable program code stored in memory 706, such as software programs 715. Software programs 715 may include one or more of the logical steps disclosed herein as a programmatic instruction, which can be executed by processor 703. Memory 706 may also include data repository 705, which may be nonvolatile memory for data persistence. The processor 703 and the memory 706 may be coupled by a bus 709. In some examples, the bus 709 may also be coupled to one or more network interface connectors 717, such as wired network interface 719, and/or wireless network interface 721. Computing device 700 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interacts with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method comprising:
receiving, through an application executed by one or more processors, a plurality of transactions and/or catalogs, the plurality of transactions and/or catalogs stored in a database in a temporary or permanent memory accessible the application;
extracting, by the application, entities from the plurality of transactions and/or catalogs;
filtering, by the application, a portion or subset of the entities from the plurality of transactions and/or catalogs;
generating, by the application, a name prompt based on a prompt template for names of each of the entities for reconciliation, the prompt template including a LLM query for a names of each of the entities find a similarity between a listed entity and a category and a likely target entity;
generating, by a LLM executed by a server, name responses based on the name prompt and parameters;
parsing, by the application, responses to generate reconciled names of each of the entities;
generating, by the application, a metadata prompt for metadata generation based on a metadata prompt template and the reconciled names of each of the entities, the metadata prompt template including a query to a metadata generation LLM to generate attributes for the reconciled names of each of the of entities;
generating, by a response LLM executed by the server, a metadata response based on metadata prompt and parameters; and
parsing responses, by the application, to generate reconciled metadata by extracting subjective attributes for the reconciled names.

2. The method of claim 1, wherein the prompt template includes a requirement to require a response in a structured format.

3. The method of claim 1, wherein the prompt template includes a requirement to require a confidence level.

4. The method of claim 1, wherein the metadata responses are filtered based on confidence level.

5. The method of claim 4, wherein if the confidence is low, the reconciled names of each of the of entities are iterated with a time, a date, or a location.

6. The method of claim 1, further comprising requesting data from an offline database, by the application from an in-memory data structure, and receiving a frequently-accessed metadata.

7. The method of claim 6, further comprising requesting data from a self-contained SQL database engine if the frequently-accessed metadata is not available or incomplete from the in-memory data structure, by the application, and receiving a second-tier metadata, wherein the self-contained SQL database engine has a higher latency than the in-memory data structure.

8. The method of claim 7, further comprising requesting data from a cold cache if the second-tier metadata is not available or incomplete from the in-memory data structure and the self-contained SQL database engine, by the application, and receiving a third-tier metadata, wherein the cold cache has a higher latency than the in-memory data structure and the self-contained SQL database engine.

9. The method of claim 8, further comprising invoking, by the application, a metadata generation LLM through an API to generate metadata if the third-tier metadata is not available or incomplete.

10. The method of claim 8, further comprising updating, by the application, a storage hierarchy by moving the second-tier metadata or the third-tier metadata to the in-memory data structure or the self-contained SQL database engine based on what information is received based on the requesting data steps.

11. A method comprising:
receiving, through an application executed by one or more processors, a plurality of transactions and/or catalogs, the plurality of transactions and/or catalogs stored in a database in a temporary or permanent memory accessible the application;
extracting, by the application, entities from the plurality of transactions and/or catalogs;
filtering, by the application, a portion or subset of the entities from the plurality of transactions and/or catalogs;
generating, by the application, a name prompt based on a prompt template for names of each of the entities, the prompt template including a LLM query for a names of each of the entities find a similarity between a listed entity and a category and a likely target entity;
generating, by a LLM executed by a server, name responses based on the name prompt and parameters;
generating, by the application, a metadata prompt for metadata generation based on a metadata prompt template, the metadata prompt template including a query to a metadata generation LLM to generate attributes for the names of each of the of entities;
querying, by the application and to a check LLM, through a verification query through a real-time search API, the verification query including a mapping to keywords and specific search parameters to formulate the real-time search API;
generating, by a response LLM executed by the server, metadata response based on metadata prompt and the parameters; and
parsing responses, by the application, to generate reconciled metadata by extracting subjective attributes for each of the entities.

12. The method of claim 11, wherein the prompt template includes a requirement to require a response in a structured format.

13. The method of claim 11, wherein the prompt template includes a requirement to require a confidence level.

14. The method of claim 11, wherein the metadata responses are filtered based on confidence level.

15. The method of claim 14, wherein if the confidence is low, the entities is iterated with a time, a date, or a location.

16. The method of claim 11, further comprising requesting data from an offline database, by the application from an in-memory data structure, and receiving a frequently-accessed metadata.

17. The method of claim 16, further comprising requesting data from a self-contained SQL database engine if the frequently-accessed metadata is not available or incomplete from the in-memory data structure, by the application, and receiving a second-tier metadata, wherein the self-contained SQL database engine has a higher latency than the in-memory data structure.

18. The method of claim 17, further comprising requesting data from a cold cache if the second-tier metadata is not available or incomplete from the in-memory data structure and the self-contained SQL database engine, by the application, and receiving a third-tier metadata, wherein the cold cache has a higher latency than the in-memory data structure and the self-contained SQL database engine.

19. The method of claim 18, further comprising invoking, by the application, a metadata generation LLM through an API to generate metadata if the third-tier metadata is not available or incomplete.

20. The method of claim 18, further comprising updating, by the application, a storage hierarchy by moving the second-tier metadata or the third-tier metadata to the in-memory data structure or the self-contained SQL database engine based on what information is received based on the requesting data steps.
